(19) United States
(12) Patent Application Publication
(10) Pub. No.: US 2012/0146409 A1
(43) Pub. Date: Jun. 14, 2012

(54) SEMICONDUCTOR DEVICE HAVING DATA OUTPUT BUFFERS

(75) Inventor: Takenori SATO, Tokyo (JP)

(73) Assignee: ELPIDA MEMORY, INC., Tokyo (JP)

(21) Appl. No.: 13/315,553

(22) Filed: Dec. 9, 2011

(30) Foreign Application Priority Data
Dec. 10, 2010 (JP) 2010-275370

(51) Int. Cl. H02J 4/00

(52) U.S. Cl. 307/18

(57) ABSTRACT

A semiconductor device includes: a plurality of power supply pads to which external voltages are supplied; a plurality of data output pads; power supply main lines that are connected to the respective corresponding power supply pads in common; a plurality of power supply branch lines that are branched from the power supply main lines, respectively; a plurality of output buffers that operate with power supply voltages supplied from the respective corresponding power supply branch lines, and drive respective corresponding data output pads; and low-pass filter circuits that are provided on the respective power supply branch lines.

### BACKGROUND OF THE INVENTION

1. Field of the Invention

The present invention relates to a semiconductor device, and more particularly to a semiconductor device which can suppress propagation of noise occurring in a data output buffer to another data output buffer.

2. Description of Related Art

Semiconductor devices such as a dynamic random access memory (DRAM) have a plurality of pads, including data output pads which are connected with output buffers for outputting data to outside the chip and power supply pads to which external voltages are supplied. The plurality of pads may include a pair of data strobe pads for outputting a pair of data strobe signals: When the data strobe pads are arranged next to each other, little noise occurs from the output buffers since the pair of data strobe signals are complementary to each other. On the other hand, if two data output pads are arranged next to each other, the output buffers that output the respective output signals tend to produce noise since different (not complementary) signals can be output.

Japanese Patent Application Laid-Open No. 2009-283673 proposes a method for preventing noise propagation. In the method, two data output pads (such as DQ1 and DQ2) and two data strobe pads (DQS and DQSB) are configured to constitute respective pairs. Each pair is interposed between two power supply pads (VDDQ and VSSQ) that are connected to respective power supply main lines. The power supply main lines for different pairs are separated from each other by high resistances, whereby noise occurring in an output buffer connected to any one of the output pads is prevented from propagating to the other output buffers, or data strobe buffers that drive the data strobe pads in particular.

According to the method described in Japanese Patent Application Laid-Open No. 2009-283673, the power supply main lines for different pairs are separated by high resistances. The power supply pads assigned to each pair of output pads thus show a high wiring impedance to output buffers other than those connected to the power supply pads. Such a high wiring impedance makes it difficult to supply power to the output buffers with stability. More specifically, suppose that an output buffer momentarily needs high power. In such a case, it is not possible to supply sufficient power through the power supply pads assigned to the corresponding output pad alone, and power supply from the power supply pads assigned to other pairs of output pads is also needed. The foregoing high wiring impedance may even make the power supply from the other power supply pads insufficient.

### SUMMARY

In one embodiment, there is provided a semiconductor device that includes: a plurality of first power supply pads supplied with a first external voltage; a plurality of data output pads; a first power supply line connected in common to the first power supply pads; a plurality of output buffers connected to the first power supply line in common, each of the output buffers being connected to a corresponding one of the data output pads; and a plurality of low-pass filter circuits, each of the low-pass filter circuits being interposed between the first power supply line and a corresponding one of the output buffers.

In another embodiment, there is provided a semiconductor device that includes: a plurality of first power supply pads supplied with a first external voltage; a plurality of data output pads; a first power supply line connected in common to the first power supply pads; a plurality of output buffers, each of the output buffers operating with the first external voltage supplied from the first power supply line and drives a corresponding one of the data output pads to either one of first and second logic levels when activated; and a plurality of low-pass filter circuits, each of the low-pass filter circuits being provided for a corresponding one of the output buffers and eliminating noise occurring from operation of the corresponding one of the output buffers before the noise is propagated from the corresponding one of the output buffers to the first power supply line.

### BRIEF DESCRIPTION OF THE DRAWINGS

FIG. 1 is a block diagram indicative of the overall configuration of a semiconductor device 10 according to an embodiment of the present invention;

FIG. 2 is an overall view for explaining a layout of the semiconductor device 10 shown in FIG. 1;

FIG. 3 is a block diagram indicative of an embodiment of a data output circuit 70o which is included in the data input/output circuit 70 shown in FIG. 1;

FIG. 4 is a schematic diagram indicative of a plurality of data output circuits 70o, power supply main lines and power supply pads for supplying power to the data output circuits 70o, and data output pads and the like according to the first embodiment of the present invention;

FIG. 5 is a schematic diagram for explaining details of low-pass filter circuits 1000 in the semiconductor device according to the first embodiment of the present invention;

FIG. 6 is a chart indicative of potential changes of a power supply voltage VDD and an internal voltage VPERI over time after the power-on of the semiconductor device 10 (after an input of a power-on reset signal PON);

FIG. 7 is a schematic diagram for explaining a remedy for a problem shown in FIG. 6;

FIG. 8 is a chart indicative of potential changes of the power supply voltage VDD and the internal voltage VPERI over time after the power-on of the semiconductor device 10 (after the input of the power-on reset signal PON) under the remedy shown in FIG. 7; and

FIG. 9 is a schematic diagram for explaining details of the low-pass filter circuits 1000 in a semiconductor device according to the second embodiment of the present invention.

### DETAILED DESCRIPTION OF THE EMBODIMENTS

Preferred embodiments of the present invention will be explained below in detail with reference to the accompanying drawings.

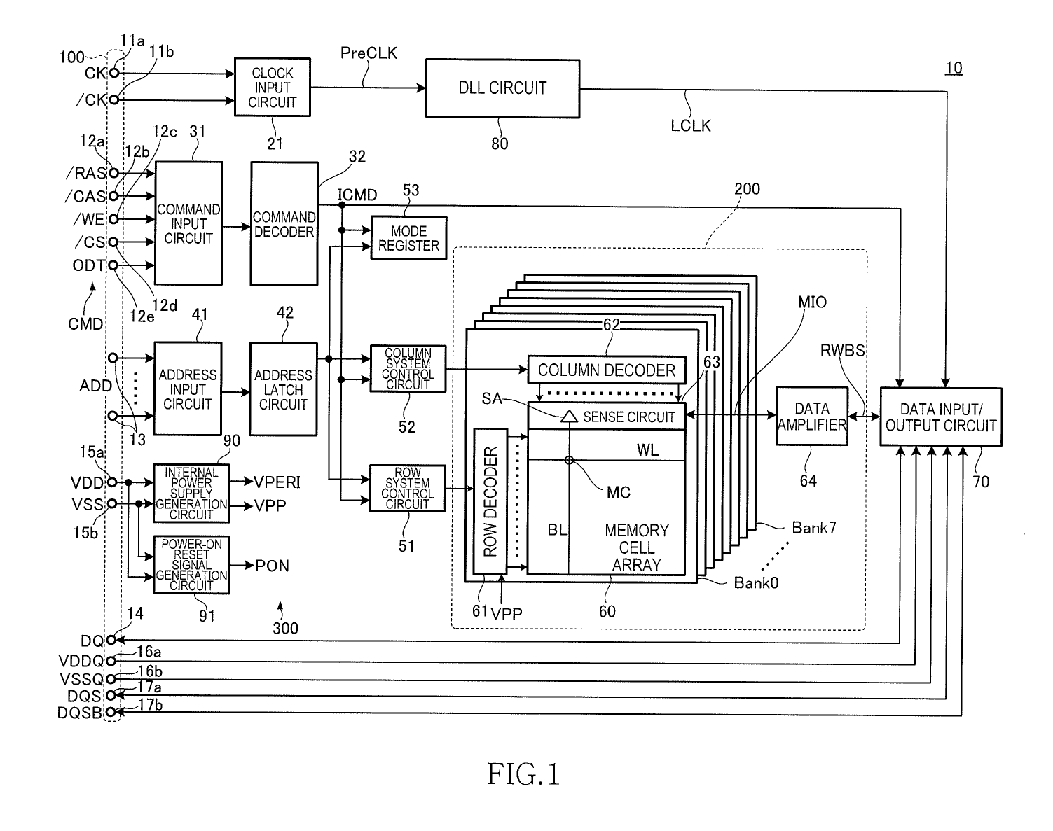

Referring now to FIG. 1, the semiconductor device 10 according to the present embodiment is a double data rate (DDR) SDRAM. The semiconductor device 10 has external terminals, including clock terminals 11a and 11b, command terminals 12a to 12e, address terminals 13, a data input/output terminal 14, power supply terminals 15a and 15b, power supply terminals for data input/output 16a and 16b, and a pair of data strobe terminals 17a and 17b. The semiconductor device 10 also includes a calibration terminal and other terminals, which are omitted from the diagram. Such a group of pads 100 are arranged in two pad rows. The actual layout will be described later.

The clock terminals 11a and 11b are terminals to which external clock signals CK and /CK are supplied, respectively. The supplied external clock signals CK and /CK are supplied to a clock input circuit 21. As employed herein, a signal having a signal name with a leading “/” is either the inverted signal of a corresponding signal or a low-active signal. The external clock signals CK and /CK are therefore complementary to each other. The clock input circuit 21 generates a single-phase internal clock signal PreCLK based on the external clock signals CK and /CK, and supplies the internal clock signal PreCLK to a DLL circuit 80. The DLL circuit 80 generates a phase-controlled internal clock LCLK based on the internal clock signal PreCLK, and supplies the internal clock LCLK to a data input/output circuit 70.

The command terminals 12a to 12e are terminals to which a row address strobe signal /RAS, a column address strobe signal /CAS, a write enable signal /WE, a chip select signal /CS, and an on-die termination signal ODT are supplied, respectively. Such command signals CMD are supplied to a command input circuit 31. The command signals CMD supplied to the command input circuit 31 are supplied to a command decoder 32. The command decoder 32 is a circuit that retains, decodes, counts, or otherwise processes the command signals to generate various internal commands ICMD. The internal commands ICMD generated are supplied to a row system control circuit 51, a column system control circuit 52, a mode register 53, the data input/output circuit 70, etc.

The address terminals 13 are terminals to which address signals ADD are supplied. The supplied address signals ADD are supplied to an address input circuit 41. The output of the address input circuit 41 is supplied to an address latch circuit 42. Among the address signals ADD latched in the address latch circuit 42, a row address is supplied to the row system control circuit 51. A column address is supplied to the column system control circuit 52. When in mode register setting, the address signals ADD are supplied to the mode register 53, whereby the content of the mode register 53 is updated.

The output of the row system control circuit 51 is supplied to a row decoder 61. The row decoder 61 is a circuit that selects any one of word lines WL included in a memory cell array 60. The memory cell array 60 includes a plurality of word lines WL and a plurality of bit lines BL which intersect each other. Memory cells MC are arranged at the intersections (FIG. 1 shows only one of the word lines WL, one of the bit lines BL, and one of the memory cells MC). The bit lines BL are connected to corresponding sense amplifiers SA in a sense circuit 63.

The output of the column system control circuit 52 is supplied to a column decoder 62. The column decoder 62 is a circuit that selects any of the sense amplifiers SA included in the sense circuit 63. The sense amplifiers SA selected by the column decoder 62 are connected to a data amplifier 64 through main I/O lines MIO. In a read operation, the data amplifier 64 further amplifies read data RD that is amplified by the sense amplifiers SA, and supplies the resultant to the data input/output circuit 70 through a read/write bus RWBS. In a write operation, the data amplifier 64 amplifies write data that is supplied from the data input/output circuit 70 through the read/write bus RWBS, and supplies the resultant to the sense amplifiers SA.

The data input/output terminal 14 is a terminal for outputting read data DQ and inputting write data DQ. The data input/output terminal 14 is connected to a data input/output circuit 70. The internal clock LCLK generated by the DLL circuit 80 is supplied to the data input/output circuit 70. In a read operation, the data input/output circuit 70 outputs read data DQ in synchronization with the internal clock LCLK. While FIG. 1 shows only one data input/output terminal 14, the number of data input/output terminals 14 need not necessarily be one. There may be provided a plurality of data input/output terminals 14.

The power supply terminals 15a and 15b are terminals to which respective power supply voltages are supplied. Specifically, a high-level power supply voltage VDD is supplied to the power supply terminal 15a. A low-level power supply voltage (ground voltage) VSS is supplied to the power supply terminal 15b. The power supply voltage VDD and the ground voltage VSS are supplied to an internal power supply generation circuit 90. The internal power supply generation circuit 90 generates an internal voltage VPERI which is intended for peripheral circuits, and an internal voltage VPP which is used as a word line voltage. The internal voltage VPERI is a voltage of approximately 1.0 V, generated by stepping down the power supply voltage VDD of approximately 1.5 V. The internal voltage VPP is a voltage of approximately 2.7 V, generated by boosting the power supply voltage VDD.

The power supply voltage VDD and the ground voltage VSS supplied from the power supply terminals 15a and 15b are also supplied to a power-on reset signal generation circuit 91. The power-on reset signal generation circuit 91 generates a power-on reset signal PON after power-on.

The power supply terminals for data input/output 16a and 16b are terminals to which respective power supply voltages for data input/output are supplied. Specifically, a high-level power supply voltage VDDQ is supplied to the power supply terminal 16a. A low-level power supply voltage (ground voltage) VSSQ is supplied to the power supply terminal 16b. The power supply voltage VDDQ and the ground voltage VSSQ are supplied to the data input/output circuit 70.

The pair of data strobe terminals 17a and 17b are terminals to which data strobe signals are supplied. The data strobe terminals 17a and 17b are connected to the data input/output circuit 70. Specifically, a data strobe signal DQS is input/output to/from the data strobe terminal 17a. The inverted signal DQSB of the data strobe signal DQS is input/output to/from the data strobe terminal 17b.

The overall configuration of the semiconductor device 10 according to the present embodiment has been described so far. Among the components shown in FIG. 1, the group of pads 100 are arranged in two pad rows. Array system circuits 200 are arranged in memory cell array regions. The remaining peripheral circuits 300 are arranged in peripheral circuit regions. The group of pads 100, as mentioned previously, are a group of external terminals including the clock terminals 11a and 11b, the command terminals 12a to 12e, the address terminals 13, the data input/output terminal 14, the power supply terminals 15a and 15b, the power supply terminals for data input/output 16a and 16b, and the data strobe terminals 17a and 17b. The array system circuits 200 refer to a group of circuits including the memory cell arrays 60, the row decoders 61, the column decoders 62, the sense amplifiers 63, and the data amplifier 64. The peripheral circuits 300 refer to all the circuits other than the array system circuits 200.

Next, the layout of the semiconductor device 10 according to the present embodiment will be described.

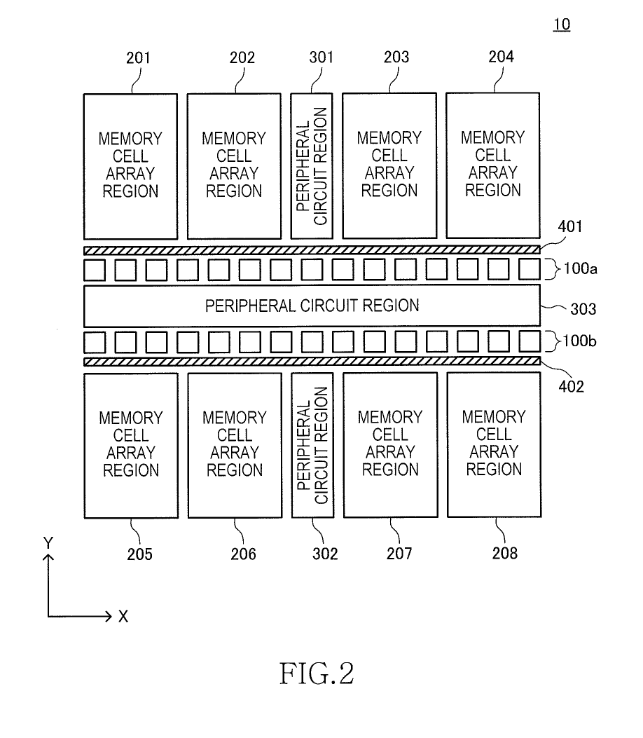

Turning to FIG. 2, the array system circuits 200 are divided and arranged in eight memory cell array regions 201 to 208. Specifically, four memory cell array regions 201 to 204 and four memory cell array regions 205 to 208, both arranged in an X direction, are placed in two rows in a Y direction.

The peripheral circuits 300 are divided into three peripheral circuit regions 301 to 303. Of these, the peripheral circuit region 301 is located in a position between the memory cell array regions 202 and 203. The peripheral circuit region 302 is located in a position between the memory cell array regions 206 and 207. The peripheral circuit region 303 is located in a position between the memory cell array regions 201 to 204 and the memory cell array regions 205 to 208 in the Y direction.

Although not particularly limited, in the peripheral circuit regions 301 and 302, fuses and other components that are included in the row system control circuit 51 and the column system control circuit 52 are allocated. In the peripheral circuit region 303, the command decoder 32, the address latch circuit 42, the data input/output circuit 70, etc are allocated.

The group of pads 100 are arranged in two pad rows 100a and 100b in the Y direction. The pad row 100a is located in a position between the peripheral circuit region 303 and the memory cell array regions 201 to 204 and peripheral circuit region 301. The pad row 100b is located in a position between the peripheral circuit region 303 and the memory cell array regions 205 to 208 and peripheral circuit region 302.

In addition, power supply main line regions 401 and 402 are arranged between the pad row 100a and the memory cell array regions 201 to 204 and peripheral circuit region 301, and between the pad row 100b and the memory cell array regions 205 to 208 and peripheral circuit region 302, respectively. The power supply main line regions 401 and 402 include a plurality of power supply main lines which extend in the X direction.

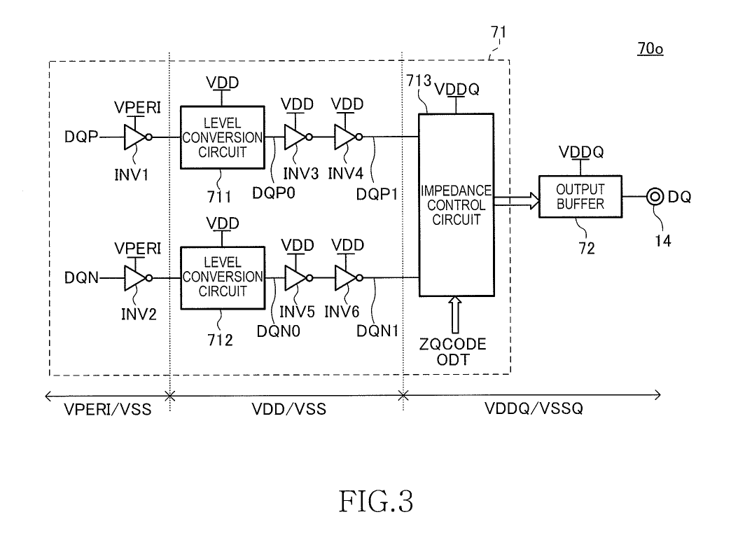

Turning to FIG. 3, the data output circuit 70o includes an output control circuit 71 and an output buffer 72. The output control circuit 71 includes level conversion circuits 711 and 712. The level conversion circuit 711 converts the amplitude of pull-up data DQP, which is supplied from the data amplifier 64 through an inverter INV1, from VPERI into VDD. The level conversion circuit 712 converts the amplitude of pull-down data DQN, which is supplied through an inverter INV2, from VPERI into VDD. Pull-up data DQP0 that is converted in level by the level conversion circuit 711 is passed through inverters INV3 and INV4, and supplied to an impedance control circuit 713 as pull-up data DPQ1. Similarly, pull-down data DQN0 that is converted in level by the level conversion circuit 712 is passed through inverters INV5 and INV6, and supplied to the impedance control circuit 713 as pull-down data DQN1. The impedance control circuit 713 receives an impedance code ZQCODE, which is generated by a calibration circuit (not shown), and the on-die termination signal ODT. Based on the impedance code ZQCODE and the on-die termination signal ODT, the impedance control circuit 713 changes the impedance of the output buffer 72. The output buffer 72 outputs an output signal DQ whose impedance is controlled by the impedance control circuit 713 to the output terminal 14.

Among the circuit components of the data output circuit 70o, the circuit block that precedes the level conversion circuits 711 and 712 is powered by and operates with the voltage (internal voltage VPERI) between an internal potential VPERI and a ground potential VSS. The circuit block from the level conversion circuits 711 and 712 up to before the impedance control circuit 713 is powered by and operates with the voltage (external voltage VDD) between an external power supply potential VDD and the ground potential VSS. The impedance control circuit 713 and the output buffer 72 are powered by and operate with the voltage (external voltage VDDQ) between an external power supply potential VDDQ and a ground potential VSSQ.

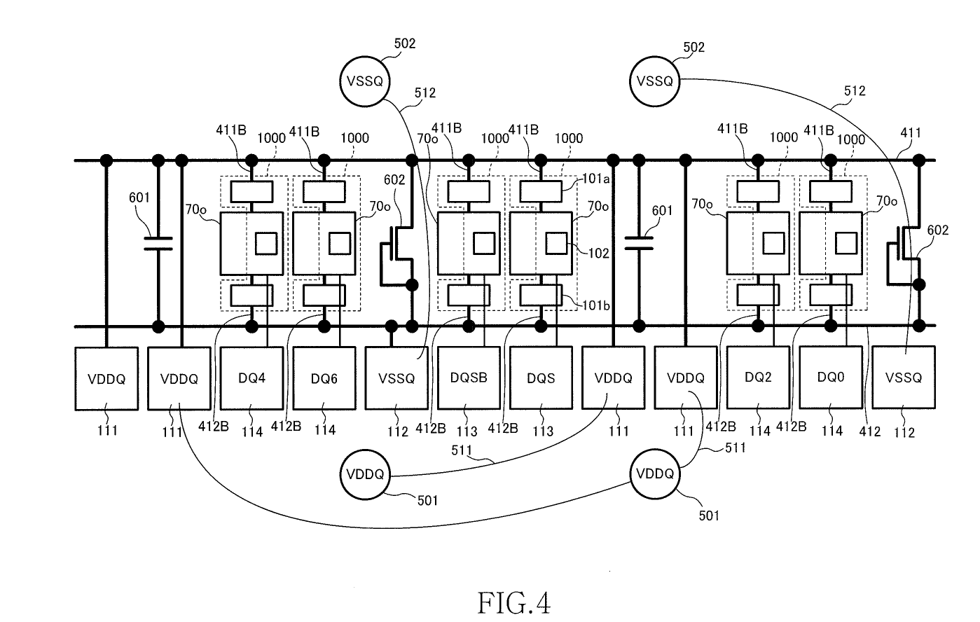

Turning to FIG. 4, the plurality of data output circuits 70o are connected in parallel between power supply main lines 411 and 412. The power supply main line 411 is connected in common to a plurality of power supply pads 111 to which the power supply voltage VDDQ is supplied as an external voltage. The power supply main line 412 is connected in common to a plurality of power supply pads 112 to which the ground voltage VSSQ is supplied as an external voltage. The power supply main line 411 is provided with a plurality of power supply branch lines 411B which are intended to supply the power supply voltage VDDQ to the output buffers 72 in the respective data output circuits 70o. The power supply main line 412 is provided with a plurality of power supply branch lines 412B which are intended to supply the ground voltage VSSQ to the output buffers 72 in the respective data output circuits 70o. The plurality of power supply pads 111 and 112 are connected to power supply balls 501 and 502 on the package by bonding wires 511 and 512, respectively. A pair of data strobe pads 113 (also referred to as data output pads) and a plurality of data output pads 114 are connected to the data output circuits 70o, respectively. The output buffers 72 in the respective data output circuits 70o drive the corresponding data strobe pads 113 and data output pads 114. The output buffers 72 that drive the data strobe pads 113 in particular will also be referred to as strobe buffers. Compensation capacitors 601 for eliminating fluctuations on the power supply main lines and protection elements 602 for anti-ESD (ElectroStatic Discharge) measures are arranged between the power supply main lines 411 and 412. The plurality of power supply branch lines 411B and 412B are provided with respective low-pass filter circuits 1000.

The low-pass filter circuits 1000 each include a resistive element 101a which is connected in series to a power supply branch line 411B, a resistive element 101b which is connected in series to a power supply branch line 412B, and a capacitive element 102 which is arranged in a data output circuit 70o.

As described above, the low-pass filter circuits 1000 are provided on the power supply branch lines 411B and 412B which supply the power supply voltages to the output buffers 72 for driving the data output pads 114 and the strobe buffers 72 for driving the data strobe pads 113. The provision of the low-pass filter circuits 1000 makes it possible to suppress the propagation of noise occurring in an output buffer 72 to the other output buffers 72, or the strobe buffers 72 in particular. Since the low-pass filter circuits 1000 are arranged not on the power supply main lines 411 and 412 themselves but on the power supply branch lines 411B and 412B, no resistive element needs to be provided on the power supply main lines 411 and 412. Consequently, total of power supplied from the plurality of power supply pads 111 and 112 can be supplied to the power supply main lines 411 and 412, which enables stable power supply to each of the output buffers 72.

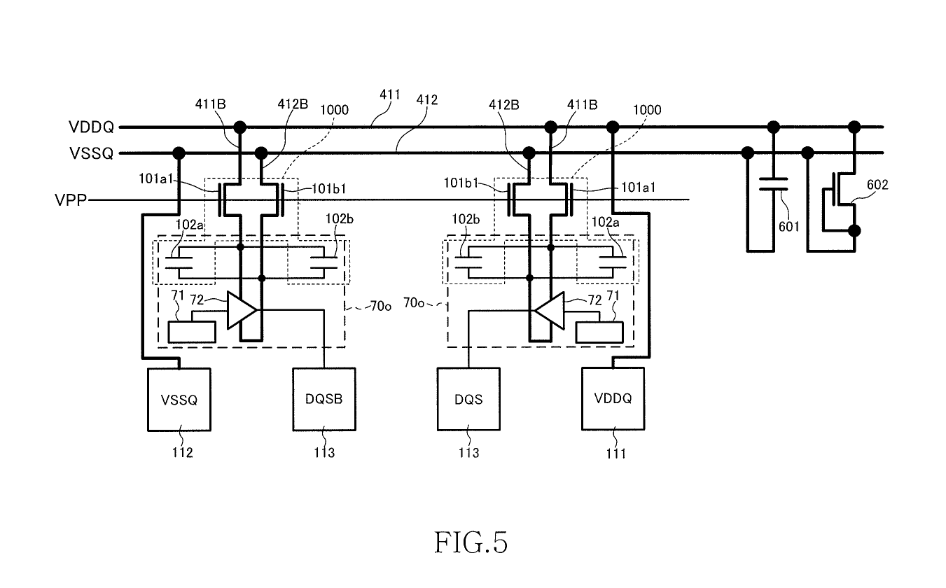

Turning to FIG. 5, it shows the vicinities of the pair of data strobe pads 113. The vicinities of the data output pads 114 have a similar configuration, and will thus be omitted from the diagram.

Referring to FIG. 5, each data output circuit 70o includes an output control circuit 71 and a strobe buffer (data output buffer) 72. The strobe buffer (data output buffer) 72 operates with the power supply voltage VDDQ and the ground voltage VSSQ, and drives a corresponding data strobe pad 113 (data output pad 114). The power supply voltage VDDQ and the ground voltage VSSQ are supplied through a power supply branch line 411B branched from the power supply main line 411 and a power supply branch line 412B branched from the power supply main line 412, respectively. As mentioned above, the power supply branch lines 411B and 412B are provided with a low-pass filter circuit 1000.

In the present embodiment, N-channel MOS transistors 101a1 and 101b1 are used as the resistive elements 101a and 101b that constitute the low-pass filter circuit 1000. The N-channel MOS transistors 101a1 and 101b1 receive the internal voltage VPP at their gate electrodes. That is, the ON resistances of clamp transistors that are fixed to an ON state in a normal operation are used as the resistive elements 101a and 101b. It is preferred that the transistors 101a1 and 101b1 be N-channel MOS transistors having a channel width of 50 to 100 μm or so, with an ON resistance of around 100Ω. The internal voltage VPP input to the gate electrodes is approximately 2.7 V as mentioned above. The power supply voltage VDDQ of approximately 1.5 V supplied to the power supply branch line 411B can thus be supplied to the strobe buffer (data output buffer) 72 with little drop.

The capacitive element 102 that constitutes the low-pass filter circuit 1000 is arranged in the form of separate capacitive elements 102a and 102b which are connected to the power supply branch lines 411B and 412B in parallel. The capacitive elements 102a and 102b have equal capacitances. It is preferred that the capacitive element 102 have a capacitance of approximately 50 pF per output. Equally divided, the capacitive elements 102a and 102b have a capacitance of approximately 25 pF each. The low-pass filter circuit 1000 can thereby provide a sufficient noise removal effect. The division of the capacitive element 102 makes it possible to arrange the capacitive elements 102a and 102b under the power supply pads 111, 112 or the data output pad 113 (114), respectively. This can prevent the peripheral circuit regions from increasing in area.

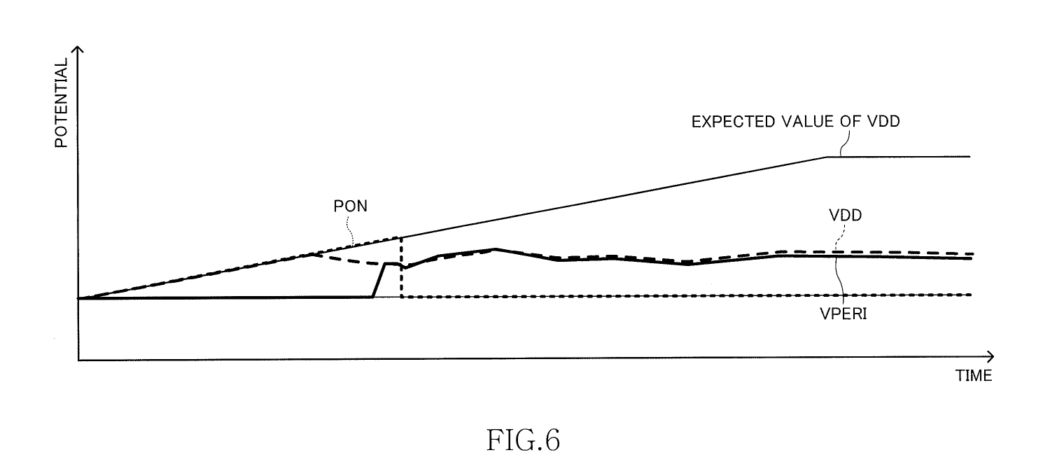

Next, a problem that may occur in the first embodiment in a certain period after power-on will be described with reference to FIG. 6.

Referring to FIG. 6, the potential of the power supply voltage VDD increases with the increasing potential of the power-on reset signal PON. In the meantime, the potential of the internal voltage VPERI generated by the internal power supply generation circuit 90 is not settled in the initial stage. As a result, for example, in the data output circuit 70o shown in FIG. 3, P-channel MOS transistors and N-channel MOS transistors included in the level conversion circuits 711 and 712, which operate between the power supply voltage VDD and the ground voltage VSS, may be simultaneously turned ON to pass a through current. This causes the problem that the power supply voltage VDD fails to increase up to the expected potential, with the result that the internal voltage VPERI also fails to increase up to the expected potential.

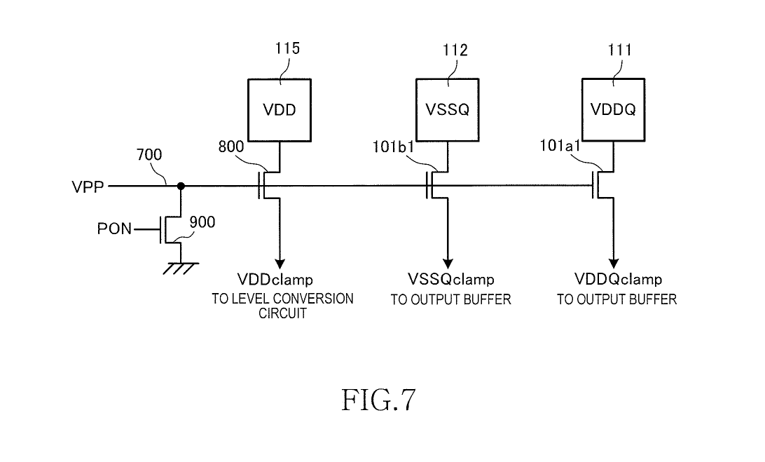

FIG. 7 shows a configuration to deal with such a problem. Referring to FIG. 7, an N-channel MOS transistor 800 is inserted into the power supply line that is in connection with the power supply pad 115 to which the power supply voltage VDD is supplied. The internal voltage VPP is input to a gate electrode of the transistor 800. There is also provided a switch circuit 900 that turns OFF the transistor 800 for a certain period after power-on. The switch circuit 900 may be composed of an N-channel MOS transistor such that a gate electrode thereof receives the power-on reset signal PON, a drain electrode thereof is connected to a supply line 700 of the internal voltage VPP, and a source electrode thereof is connected to the ground voltage.

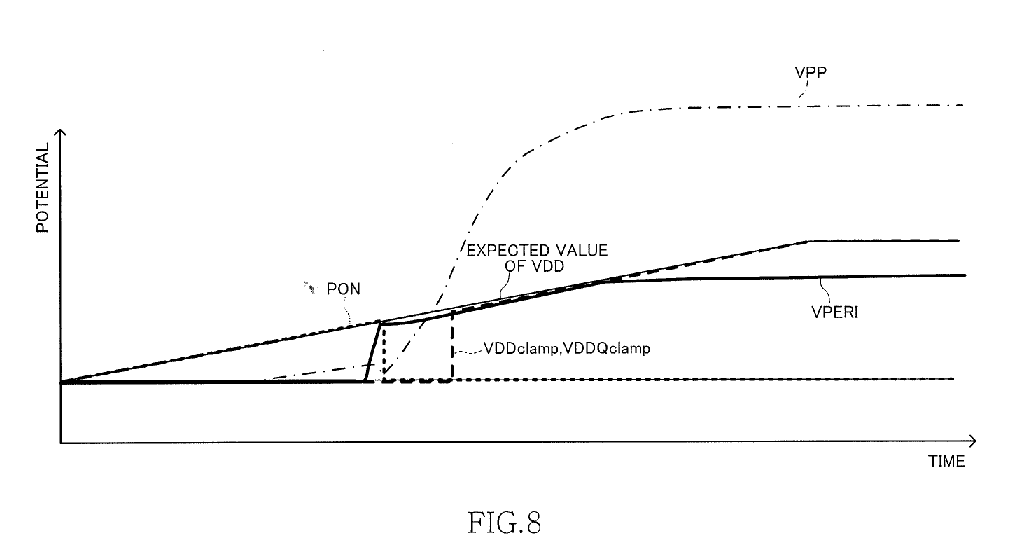

With such a configuration, while the power-on reset signal PON is at a high level, the transistor 900 turns ON to bring the potential of the supply line 700 of the internal voltage VPP down to the ground potential. This turns OFF the transistor 800. Turning to FIG. 8, the potential VDDclamp at the source electrode of the transistor 800 will not rise since the power supply voltage VDD is not supplied to the source electrode of the transistor 800. Subsequently, when the power-on reset signal PON changes to a low level, the transistor 900 turns OFF and the potential of the internal voltage VPP rises to turn ON the transistor 800. By this point in time, the potential of the internal voltage VPERI is sufficiently high. The potential VDDclamp at the source electrode of the transistor 800 then rises up to the expected value without problem.

While the power-on reset signal PON is input, the supply of the power supply voltage VDD to the level conversion circuits 711 and 712 is stopped. In the output circuit 70o shown in FIG. 3, a through current may flow through the output buffer 72 because the potentials input to the output buffer 72, which operates between the power supply voltage VDDQ and the ground voltage VSSQ, are not settled. According to the first embodiment, as shown in FIG. 5, the transistor 101a1 is interposed between the power supply pad 111, to which the power supply voltage VDDQ is supplied, and the output buffer 72. The transistor 101b1 is interposed between the power supply pad 112, to which the ground voltage VSSQ is supplied, and the output buffer 72. The transistors 101a1 and 101b1 receive the internal voltage VPP at their gate electrodes. The provision of such transistors 101a1 and 101b1 translates into the configuration shown in FIG. 7. More specifically, while the potential of the power-on reset signal PON is input, the switch circuit (transistor) 900 turns ON to bring the potential of the supply line 700 of the internal voltage VPP to the ground potential. This turns OFF the transistors 101a1 and 101b1 as well as the transistor 800. Consequently, the potential VDDQclamp at the source electrode of the transistor 101a1 will not rise because the power supply voltage VDDQ is not supplied to the source electrode of the transistor 101a1. The ground potential VSSQ is not supplied to the electrode opposite from the electrode pad 112 of the transistor 101b1, either. Subsequently, the power-on reset signal PON ends being input, and the switch circuit (transistor) 900 turns OFF and the potential of the internal voltage VPP rises to turn ON the transistor 101a1. As a result, like VDDclamp, the potential VDDQclamp at the source electrode of the transistor 101a1 rises up to the expected value without problem. The ground potential VSSQ is also supplied to the electrode opposite from the electrode pad 112 as a potential VSSQclamp.

As described above, the application of the switch circuit 900 in the first embodiment enables stable supply of the power supply voltage VDDQ and the ground voltage VSSQ to the output buffers.

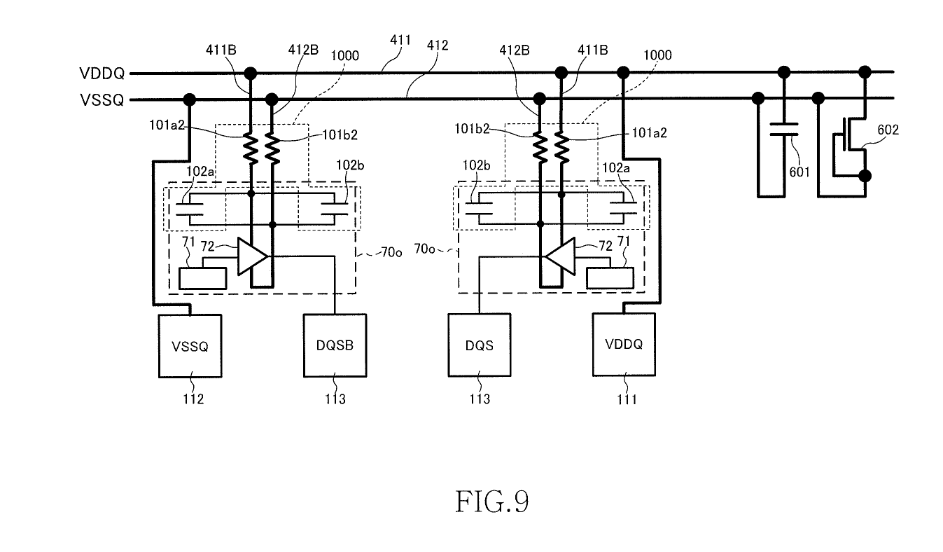

Next, a second preferred embodiment of the present invention will be described with reference to FIG. 9.

Referring to FIG. 9, the present embodiment differs from the foregoing first embodiment in that resistive elements 101a2 and 101b2 made of tungsten or the like are used as the resistive elements 101a and 101b. In other respects, the present embodiment is the same as the first embodiment. The same components will thus be designated by like reference numerals. Redundant description will be omitted.

In the present embodiment, the present invention is applied not to an internal step-down product which uses an internal voltage VPERI that is stepped down inside the semiconductor device, but to a semiconductor device that uses the intact power supply voltage VDD inside. That is, the disuse of the internal voltage VPERI stepped down inside the semiconductor device precludes the problem that has been described in conjunction with FIG. 6. In the present embodiment, the resistive elements 101a2 and 101b2 made of tungsten or the like can thus be used as the resistive elements 101a and 101b instead of transistors. Consequently, according to the present embodiment, it is possible to simplify the circuit configuration as compared to the first embodiment.

It is apparent that the present invention is not limited to the above embodiments, but may be modified and changed without departing from the scope and spirit of the invention.

What is claimed is:

1. A semiconductor device comprising:
a plurality of first power supply pads supplied with a first external voltage;
a plurality of data output pads;
a first power supply line connected in common to the first power supply pads;
a plurality of output buffers connected to the first power supply line in common, each of the output buffers being connected to a corresponding one of the data output pads; and
a plurality of low-pass filter circuits each interposed between the first power supply line and a corresponding one of the output buffers.

2. The semiconductor device as claimed in claim 1, further comprising:
a plurality of second power supply pads supplied with a second external voltage; and
a second power supply line connected in common to the second power supply pads,
wherein each of the low-pass filter circuits includes a first resistive element connected between the first power supply line and the corresponding one of the output buffers, and a first capacitive element having one electrode connected to one end of the first resistive element and other electrode connected to the second power supply line.

3. The semiconductor device as claimed in claim 2, wherein each of the low-pass filter circuits further includes a second resistive element connected between the second power supply line and the corresponding one of the output buffers, and a second capacitive element having one electrode connected to one end of the second resistive element and other electrode connected to the first power supply line.

4. The semiconductor device as claimed in claim 2, wherein the first resistive element in each of the low-pass filter circuits includes a first transistor.

5. The semiconductor device as claimed in claim 4, further comprising a control circuit supplying a control signal to a control electrode of the first transistor in each of the low-pass filter circuits, the control circuit bringing the first transistor in each of the low-pass filter circuits into an nonconductive state in a first period after starting to supply the first and second external voltages.

6. The semiconductor device as claimed in claim 5, further comprising a first internal voltage generation circuit generating a first internal voltage based on the first external voltage,
wherein the control circuit supplies the first internal voltage to the control electrode of the first transistor in each of the low-pass filter circuits to bring the first transistor in each of the low-pass filter circuits into a conductive state in a second period subsequent to the first period.

7. The semiconductor device as claimed in claim 5, further comprising:
a second internal voltage generation circuit generating a second internal voltage based on the first external voltage; and
an internal circuit supplying an input signal to the output buffers,
wherein the internal circuit operates on the second internal voltage.

8. The semiconductor device as claimed in claim 7, further comprising a second transistor interposed between the first power supply pads and the second internal voltage generation circuit,
wherein the control circuit supplies the control signal to a control electrode of the second transistor.

9. The semiconductor device as claimed in claim 7, wherein the first internal voltage is higher than the first external voltage, and the second internal voltage is lower than the first external voltage.

10. The semiconductor device as claimed in claim 1, further comprising:
a pair of data strobe pads; and
a pair of strobe buffers connected to the first power supply line in common, each of the pair of strobe buffers driving a corresponding one of the pair of data strobe pads at substantially a same timing as that at which each of the output buffers drives the corresponding one of the data output pads.

11. A semiconductor device comprising:
a plurality of first power supply pads supplied with a first external voltage;
a plurality of data output pads;
a first power supply line connected in common to the first power supply pads;
a plurality of output buffers operating on the first external voltage supplied from the first power supply line, each of the output buffers driving a corresponding one of the data output pads to either one of first and second logic levels when activated; and
a plurality of low-pass filter circuits each provided for a corresponding one of the output buffers and attenuating a noise caused by an operation of the corresponding one of the output buffers before the noise reaches to the first power supply line.

12. The semiconductor device as claimed in claim 11, further comprising:
a plurality of second power supply pads supplied with a second external voltage; and
a second power supply line connected in common to the second power supply pads,
wherein each of the low-pass filter circuits includes a first resistive element connected between the first power supply line and the corresponding one of the output buffers, and a first capacitive element having one electrode connected to one end of the first resistive element and other electrode connected to the second power supply line.

13. The semiconductor device as claimed in claim 12, wherein each of the low-pass filter circuits further includes a second resistive element connected between the second power supply line and the corresponding one of the output buffers, and a second capacitive element having one electrode connected to one end of the second resistive element and other electrode connected to the first power supply line.

14. The semiconductor device as claimed in claim 12, wherein the first resistive element in each of the low-pass filter circuits includes a first transistor.

15. The semiconductor device as claimed in claim 14, further comprising a control circuit supplying a control signal to a control electrode of the first transistor in each of the low-pass filter circuits, the control circuit bringing the first transistor in each of the low-pass filter circuits into an nonconductive state in a first period after starting to supply the first and second external voltages.

16. The semiconductor device as claimed in claim 15, further comprising a first internal voltage generation circuit generating a first internal voltage based on the first external voltage,
wherein the control circuit supplies the first internal voltage to the control electrode of the first transistor in each of the low-pass filter circuits to bring the first transistor in each of the low-pass filter circuits into a conductive state in a second period subsequent to the first period.

17. The semiconductor device as claimed in claim 15, further comprising:
a second internal voltage generation circuit generating a second internal voltage based on the first external voltage; and
an internal circuit supplying an input signal to the output buffers,
wherein the internal circuit operates on the second internal voltage.

18. The semiconductor device as claimed in claim 17, further comprising a second transistor interposed between the first power supply pads and the second internal voltage generation circuit,
wherein the control circuit supplies the control signal to a control electrode of the second transistor.

19. The semiconductor device as claimed in claim 17, wherein the first internal voltage is higher than the first external voltage, and the second internal voltage is lower than the first external voltage.

20. The semiconductor device as claimed in claim 11, wherein
the data output pads include a plurality of data strobe pads, and
the output buffers include a plurality of strobe buffers, each of the strobe buffers driving a corresponding one of the data strobe pads to either one of the first and second logic levels.
